(19) United States
(12) Patent Application Publication
(10) Pub. No.: US 2024/0346281 A1
(43) Pub. Date: Oct. 17, 2024

(54) TYRE GAUGE

(71) Applicant: ATMS TECHNOLOGY LIMITED, London (GB)

(72) Inventors: John Peter Beckley, London (GB); David Michael FORD, London (GB)

(21) Appl. No.: 18/575,169

(22) PCT Filed: Jul. 1, 2022
(86) PCT No.: PCT/GB2022/051703

§ 371 Date: Dec. 28, 2023

(30) Foreign Application Priority Data
Jul. 2, 2021 (GB) 2109638.3

(51) Int. Cl. G06K 19/077; G01B 7/26; G01B 11/22; G01M 17/02

(52) U.S. Cl. CPC G06K 19/07764; G01B 7/26; G01B 11/22; G01M 17/027

(57) ABSTRACT

There is disclosed a tyre gauge comprising: an RFID device; a sensor arranged to obtain a measurement from a tyre; and a means for writing the measurement to the RFID device. The means for writing may comprise a wire and/or a cable connecting the sensor to the RFID device such that the sensor is able to write the measurement to the RFID device.

### FIELD OF THE DISCLOSURE

The present disclosure relates to a tyre gauge as well as a method of operating the tyre gauge, a system comprising the tyre gauge, and a computer device for use in the system.

### BACKGROUND TO THE DISCLOSURE

In order to measure the wear on tyres, and in particular the tread depth of a tyre, a tread depth gauge may be used.

As shown in FIG. 1a, a conventional tread depth gauge comprises a probe 12 that is located within a barrel 14 such that the probe is able to move along the barrel. A measuring scale 16 is provided on the probe that indicates the amount of movement of the probe along the barrel, where a value is read from the part of the measurement scale that is level with the top of the barrel. Such a scale typically shows a value of zero when the bottom of the probe is level with the bottom of the barrel and then shows an increasing value as the bottom of the probe is moved out of the bottom of the barrel.

As shown in FIG. 1b, in order to use the tread depth gauge, the gauge is placed on a tyre such that the probe is located above a groove in the tyre. Protrusions at the base of the barrel 14 are arranged to abut the surface of the tyre to either side of the groove to ensure that the gauge is properly located. The probe 12 is then pushed along the barrel so that the bottom of the probe moves out of the bottom of the barrel and into the groove. Once the bottom of the probe contacts the base of the groove, the depth of the tread is measured by reading the value on the measuring scale 16.

Such a conventional gauge can provide an accurate measurement of tread depth; however, in order to make best use of this tread depth the user may need to consider a plurality of measurements and/or perform calculations based on tread depth measurements. With conventional gauges, such additional work is not straightforward.

### SUMMARY OF THE DISCLOSURE

According to at least one aspect of the present disclosure, there is provided a tyre gauge comprising: an RFID device (e.g. an RFID tag); a sensor arranged to obtain a measurement from a tyre; and a means for writing (e.g. a transmitter and/or a communication interface) the measurement to the RFID device.

The RFID device may be integrated with one or more other components of the gauge.

Preferably, the means for writing comprises a transmitter arranged to emit an electromagnetic wave containing the measurement so as to write the measurement to the RFID device.

Preferably, the tyre gauge and/or the means for writing comprises a wire and/or a cable connecting the sensor to the RFID device such that the sensor is able to write the measurement to the RFID device.

Preferably, the means for writing is arranged to clear data on the RFID device. Preferably, the means for writing is arranged to clear data on the RFID device in dependence on a user input.

Preferably, the means for writing is arranged to write a plurality of measurements to the RFID device.

Preferably, the means for writing is arranged to append a measurement to data already on the RFID device.

Preferably, the means for writing is arranged to overwrite data on the RFID device.

Preferably, the tyre gauge comprises a power supply, wherein the power supply is arranged to provide power to one or more of: the RFID device, the sensor, and the means for writing, preferably wherein the power supply is arranged to receive power from a device reading data from the RFID device.

Preferably, the tyre gauge comprises a passive RFID device.

Preferably, the tyre gauge comprises an active RFID device.

Preferably, the RFID device is arranged to be written to and/or read from using near-field communication (NFC) and/or ultra high frequency (UHF) protocols.

Preferably, the tyre gauge is arranged so that the measurement on the RFID device is cleared and/or overwritten upon the measurement being read by a separate computer device.

Preferably, a mode of the RFID device is dependent on one or more of: a time between successive measurements; a user input; and an input from a separate computer device.

Preferably, in a first mode the means for writing is arranged to append the measurement to data already on the RFID device. Preferably, in a second mode the means for writing is arranged to clear and/or overwrite data already on the RFID device.

Preferably, the tyre gauge comprises a user input.

Preferably, the RFID device is arranged to transmit the measurement to a separate computer device in dependence on operation of the user input.

Preferably, the user input is arranged to enable the user to select a tyre with which to associate a measurement.

Preferably, the user input is arranged to enable the user to select a mode of operation and/or a template.

Preferably, the user input is arranged to enable the user to alter user preferences and/or to select a user profile.

Preferably, the measurement is written to the RFID device in dependence on the user input.

Preferably, the measurement is written from a memory of the tyre gauge to the RFID device of the tyre gauge in dependence on the user input.

Preferably the tyre gauge comprises memory (e.g. flash memory) for storing the measurement. Preferably the tyre gauge comprises memory (e.g. flash memory) for storing the measurement before writing to the RFID device.

Preferably, the tyre gauge is arranged to identify a tyre and/or vehicle associated with the measurement. Preferably, the tyre gauge is arranged to identify a tyre and/or vehicle associated with the measurement by reading an RFID chip associated with the tyre and/or vehicle.

Preferably, the means for writing is arranged to include in the electromagnetic wave an identifier of a tyre and/or vehicle associated with the measurement.

Preferably, the tyre gauge further comprises a display.

Preferably, the display is arranged to indicate to a user a measurement to be taken.

Preferably, the display is arranged to indicate a current measurement to a user.

Preferably, the display is arranged to operate in dependence on an input from a separate computer device.

Preferably, the tyre gauge further comprises a manual sensor.

Preferably, the tyre gauge is a tyre tread depth gauge.

Preferably, the tyre gauge is one or more of: a temperature gauge, and a pressure gauge.

Preferably, the RFID device is removable from the tyre gauge.

According to another aspect of the present disclosure, there is provided a system comprising: the tyre gauge as aforesaid; and a computer device arranged to read the measurement from the RFID device.

Preferably, the computer device comprises a processor arranged to associate a measurement on the RFID device with a tyre.

Preferably, the computer device comprises random access memory (RAM) arranged to store the measurement.

Preferably, the computer device comprises a user interface.

Preferably, the user interface is arranged to indicate a measurement for a user to obtain. Preferably, the user interface is arranged to indicate one or more tyre measurements for the user to obtain.

Preferably, the user interface is arranged to receive a user input relating to a measurement on the RFID device. Preferably, the user interface is arranged to receive an indication of a tyre to be associated with the measurement.

Preferably, the user interface is arranged to receive a user input relating to a measurement to be taken by the RFID device. Preferably, the user interface is arranged to receive an indication of a tyre to be associated with the measurement.

Preferably, the user interface is arranged to indicate a measurement that has been taken. Preferably, the user interface is arranged to indicate a tyre that is associated with a previous measurement.

Preferably, the user interface is arranged to indicate a remaining measurement to be taken. Preferably, the user interface is arranged to indicate a tyre for which no associated measurement has been taken.

Preferably, the computer device comprises a communication interface arranged to overwrite and/or clear the RFID device. Preferably, the transmitter is arranged to overwrite and/or clear the RFID device following the reading of the measurement from the RFID device.

Preferably, the computer device comprises a communication interface arranged to transmit the measurement to a remote server.

Preferably, the system includes the remote server. Preferably, the server is arranged to analyse a plurality of measurements. Preferably, the plurality of measurements are associated with one or more of: a plurality of vehicles; a plurality of times; and a plurality of drivers.

Preferably, the computer device comprises a processor arranged to perform analysis on one or more measurements read from the RFID device.

Preferably, the system comprises a plurality of tyre gauges. Preferably, the computer device and/or the remote server is arranged to receive measurements from each of the plurality of tyre gauges.

Preferably, the system comprises a plurality of computer devices.

Preferably, each computer device is arranged to read a measurement from the RFID device.

Preferably, each computer device is arranged to transmit the measurement to a remote server.

According to another aspect of the present disclosure, there is provided the computer device of the aforesaid system and/or the remote server of the aforesaid system.

According to another aspect of the present disclosure, there is provided a computer device comprising a communication interface arranged to read a measurement from the RFID device of the aforesaid tyre gauge. Preferably, the communication interface comprises an RFID interface and/or an NFC interface and/or a UHF interface.

According to another aspect of the present disclosure, there is provided a method of obtaining a measurement relating to a tyre, the method comprising: obtaining a measurement from the tyre using a sensor of a tyre gauge; writing the measurement to an RFID device of the tyre gauge using a writing means of the tyre gauge; and reading the measurement from the RFID device using a separate computer device.

Preferably, the method comprises associating the measurement with a tyre using the computer device.

Preferably, associating the measurement with a tyre comprises obtaining the measurement for a tyre indicated on the computer device.

Preferably, associating the measurement with a tyre comprises inputting to the computer device an indication of a tyre associated with the measurement.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

As used herein, the term ‘gauge’ preferably connotes any device that is arranged to measure a property (e.g. a depth, a pressure, and/or a temperature). The gauge may or may not be arranged to display this property, so that the gauge as described may measure the property and then store the measurement in an RFID device/tag so that it can later be accessed by a user.

The disclosure will now be described, by way of example, with reference to the accompanying drawings.

### DESCRIPTION OF THE DRAWINGS

FIGS. 1a and 1b illustrate the use of a conventional tread depth gauge;

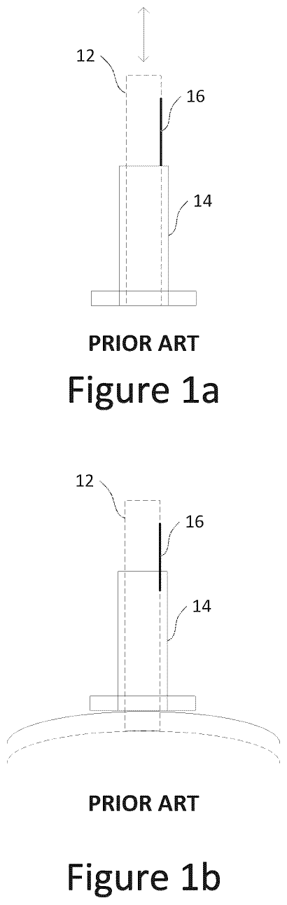

FIG. 2 shows a tread depth gauge according to the present disclosure;

FIGS. 3a and 3b show a computer device that may be used with the tread depth gauge; and

FIGS. 4a and 4b show another embodiment of the tread depth gauge; and

FIGS. 5a and 5b shows a system comprising the tread depth gauge and the computer device.

### DESCRIPTION OF THE PREFERRED EMBODIMENTS

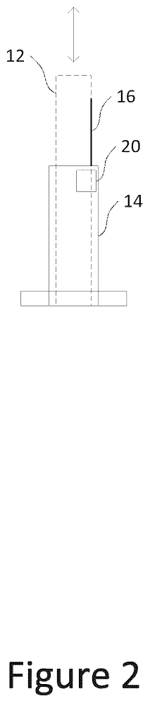

Referring to FIG. 2, there is shown a tyre tread depth gauge according to the present disclosure.

The tread depth gauge comprises a radio frequency identification (RFID) tag 20. The RFID tag is arranged to interact with the measurement scale 16 in order to store measurements taken by the gauge. More generally, the tread depth gauge comprises an RFID device that can be written to and/or read from using RFID protocols (e.g. a loop of wire located internally to the tread depth gauge).

Typically, this comprises the tread depth gauge comprising a transmitter so that measurements from the measurement scale 16 are transmitted to the RFID tag 20. For example, the tread depth gauge may comprise an electronic sensor located on the inside of the barrel 14 that interprets the measurement scale and transmit the measurements to the RFID tag.

The measurements can thereafter be transmitted from the RFID tag 20 to a separate computer device, such as a smartphone, a tablet, or a computer. This provides a straightforward way for tread depth readings to be uploaded to such a computer device for more detailed analysis.

A benefit of using an RFID tag in this way is that the computer device does not need to connect to the RFID device or undergo any pairing procedure before reading the measurements (in contrast to, say, a Bluetooth® enabled tread depth gauge). Therefore the tread depth gauge is simple to use and provides a pleasurable user experience. Furthermore, the tread depth gauge can be provided at a low cost, not least due to the low power usage of the RFID tag 20.

The tread depth gauge may comprise one or more of:
An electronic sensor, e.g. an infrared sensor and/or a capacitive sensor, that is arranged to measure the amount of movement of the probe 12 along the barrel 14.

In some embodiments, the tyre gauge comprises an electronic circuit that is arranged to both take a measurement and to transmit the measurement to the RFID tag 20. For example, a single analogue circuit may use capacitive sensing to take a tread depth measurement and then communicate the measurement to the RFID tag (e.g. via a wire).
A manual sensor. The tread depth gauge typically comprises a manual (e.g. non-electronic) sensor, such as a magnifying glass or a moveable measuring gauge as described above. This enables the tread depth gauge to be used in a manner similar to a conventional gauge if the electronics of the gauge are not working.
A transmitter that is arranged to write measurements taken by the sensor/measurement scale 16 onto the RFID tag 20. Typically, this comprises the transmitter transmitting an electromagnetic wave in which the measurements are encoded. This electromagnetic wave is detected by the RFID tag and used to write one or more values to the RFID tag. More generally, there is provided a means for writing measurements to the RFID tag (e.g. a communication interface for writing measurements to the RFID tag). This means for writing may be wireless, or may be wired (e.g. the RFID tag may be connected to the sensor by a wire, or a cable, so that the sensor can write measurements to the RFID tag via the wire).
A power supply that is arranged to provide power to the sensor, the RFID tag 20, and/or the transmitter. The power supply may be rechargeable and/or changeable (e.g. the power supply may comprise a battery). The power supply may be arranged to receive power and/or to be recharged by an external device. In particular, the power supply may be arranged to receive power, suitably via the RFID tag, from an external device when this external device is used to read measurements from the RFID tag.

Typically, the RFID tag 20 is arranged to be read from/written to using near-field communication (NFC). This is particularly beneficial since many existing computer devices are able to use NFC protocols. A tread depth gauge that uses NFC can thus be used with existing devices with minimal configuration.

In some embodiments, the RFID tag 20 is arranged to be read from/written to using ultra-high frequency (UHF) signals (e.g. signals with a frequency between 300 MHz-3 GHZ).

In some embodiments, a plurality of components of the tread depth gauge are embedded in a single module. For example, two or more of (or all of) the RFID tag 20, the sensor, the power supply, and a processor/control unit may be embedded into a single piece of silicon that comprises the tread depth gauge. Equally, one or more of the components may be separated form the other components, e.g. the RFID tag 20 may be separate to the other components so that it can be removed from, or placed on, the tread depth gauge.

It will be appreciated that the tread depth gauge may also be implemented electronically. For example, the probe 12 may be replaced with an infrared sensor that is directed to emit infrared light through the barrel 14 into a groove of the tyre and to detect the return of this light in order to determine a tread depth. Equally, the probe may be replaced with a capacitive sensor. More generally, any type of tread depth gauge may be used to obtain the measurements. Regardless of how the measurements are obtained, these measurements are then stored in the RFID tag 20.

In order to store the reading in the RFID tag 20, the sensor and/or the transmitter is arranged to produce an electromagnetic wave that is received by the RFID tag. This electromagnetic wave includes the measurements taken by the measurement scale 16 so that these measurements are written to the RFID tag. By producing different forms of electromagnetic waves, the RFID tag can either be overwritten or measurements can be appended to a list of measurements already present on the RFID tag.

In order to read the RFID tag 20, the computer device is arranged to receive an electromagnetic wave that is produced by the RFID tag.

The RFID tag 20 may be either passive or active. A passive tag does not have its own power supply and instead is powered by electromagnetic waves received by the RFID tag (e.g. from the sensor and/or the computer device). Therefore, the RFID tag may receive power from an electromagnetic wave emitted by the computer device and thereafter emit a separate electromagnetic wave to the computer device, which includes the measurements stored on the RFID tag. The use of a passive tag simplifies the manufacture and maintenance of the tread depth gauge; however, such a passive tag generally requires the computer device to be nearby to read from/write to the tag.

An active tag is powered, e.g. by the power supply, and can be read from/written to from a further distance as compared to a passive tag. Furthermore, an active tag does not require power from an external source to operate.

The RFID tag 20 is arranged to be rewritable, in particular to be repeatedly rewritable. This enables the RFID tag to be written to each time a tread depth is measured. The RFID tag may be arranged to store only a single measurement (to avoid any confusion between measurements) and/or the RFID tag may be arranged to store a plurality of measurements. By providing an RFID tag capable of storing a plurality of measurements, a user is able to measure, for example, the tread depth of each wheel of a vehicle before reading these measurements using a computer device.

In practice, the RFID tag 20 may be arranged to store a first plurality of measurements for a first tyre (or first set of tyres), where this first plurality of measurements can be read by the computer device. The tread depth gauge may then be arranged so that a second plurality of measurements overwrites the first plurality of measurements on the RFID tag (to avoid a measurement being read twice by the computer device). Equally, the tread depth gauge may be arranged so that the RFID tag is cleared once the first plurality of measurements have been read. This may be implemented using a plurality of modes, in particular in a first mode measurements may be appended to the RFID tag whereas in a second mode the RFID tag may be overwritten/cleared. The switching between modes and/or the overwriting/clearing of the first plurality of measurements may be based on:
A time between measurements; e.g. the sensor and/or transmitter may be arranged so that if the time between two successive measurements exceeds a threshold the data on the RFID tag 20 is cleared/overwritten.
A user input; e.g. the tread depth gauge may comprise a user input button, wherein the operation of the user input results in the RFID tag 20 being cleared/overwritten. This user input may be combined with a user input that causes the RFID tag to emit an electromagnetic wave. Therefore, the measurements may be read by a computer device and then cleared immediately.
The computer device. The computer device may be arranged to clear the RFID tag 20 once the computer device has received the first plurality of measurements. Typically, this comprises the computer device being arranged to provide an electromagnetic wave that clears the data from the RFID tag.

In some embodiments, the tread depth gauge comprises a user input, where the operation of the user input results in the RFID tag 20 emitting an electromagnetic wave comprising the measurements. Therefore, the user may place the tag near a computer device and then operate the user input so that the measurements can be read by the computer device. Equally, the computer device may be arranged to read the measurements based on a user input on the computer device and/or based on a detected proximity of the RFID tag.

The tread depth gauge may comprise a processor arranged to process the measured tread depths; however, typically the tread depth gauge is provided with only minimal componentry so that the tread depth gauge is cheap and robust.

Therefore, the tread depth gauge is typically arranged to interact with a computer device so as to provide the measurements on the RFID tag 20 to the computer device. The computer device (and/or a further device) is then used to perform detailed analysis of the measurements.

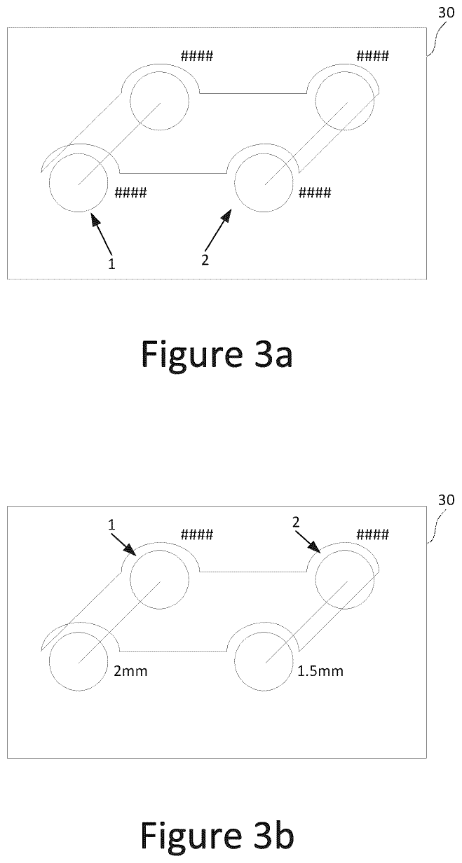

Referring to FIGS. 3a and 3b, an exemplary user interface of a computer device 30 is shown and exemplary operations of the computer device are described.

Typically, the computer device 30 comprises one or more of: a processor arranged to execute instructions; a communication interface arranged to receive and/or transmit data (e.g. an RFID interface and/or an NFC interface); and a memory arranged to store information, such as instructions for the processor and measurements from the tread depth gauge.

Referring to FIG. 3a, the computer device 30 is arranged to receive the measurements from the RFID tag 20. So that the received measurements can be associated with a relevant tyre and/or groove, the computer device is typically arranged to indicate a measurement to be read next and/or to query a measurement that has just been read.

As shown in FIG. 3a, the computer device 30 may be arranged to show one or more measurements to be taken, such as a first measurement for a front-left tyre tread depth and a second measurement for a rear-left tyre tread depth. Once those measurements have been taken, the user is able to use the computer device to read the RFID tag 20 (e.g. by placing the RFID tag next to the computer device) so that the computer device can receive measurements from the RFID tag and relate these to the correct tyres (as shown in FIG. 3b). The measurements may then be stored in the memory of the computer device and/or in random access memory (RAM) of the computer device.

In practice, the computer device 30 may indicate to a user that these two measurements are required; the user then measures first the tread depth of the front-left tyre and second the tread depth of the rear-left tyre; then the user locates the RFID tag 20 of the tread depth gauge near the computer device. The computer device reads the two measurements from the RFID tag and associates them with the correct tyres based on the indicated order. The RFID tag may then be cleared and/or overwritten in order to ensure these measurements are not inadvertently reused.

Equally, the computer device may be arranged to receive one or more measurements and then to query the user as to the nature of these measurements. For example, the user may be able to read two measurements into the computer device 30 by placing the RFID tag 20 next to the computer device. The user may be able to input that these measurements relate respectively to the front-left tyre and the rear-left tyre.

Typically, the user is able to specify the measurements that are being entered or that will be entered. For example, the user may be able to select one or more tyres for which a reading is going to be taken. The computer device 30 is then able to receive the measurements and relate these to the correct tyres. This enables the user to choose a number of measurements to be taken and an order of measurements based on the user's situation (e.g. some users may prefer to measure all of the tyres and then upload a single set of measurements to the computer device, some users may prefer to measure a single tyre at a time and to each upload the measurement after each tyre).

Typically, the computer device 30 is arranged to provide an indication of the expected measurements and/or the remaining measurements. Referring to FIG. 3b, it can be seen that measurements for the front-left tyre and the rear-left tyre have been received by the computer device but that measurements for the front-right tyre and the rear-right tyre are still expected.

The provision of a user interface that works in combination with the tread depth gauge enables a straightforward and pleasant user experience as well as providing a way to enable the computer device 30 to interpret the information read from the RFID tag 20.

The computer device 30 is typically arranged to process the received information and/or to provide feedback to the user, e.g. to suggest that a tyre is replaced and/or to suggest a rotation of the tyres. Furthermore, the computer device may be arranged to transmit the information to a remote server, where more detailed analysis can be performed. This enables a user to receive immediate feedback relating to straightforward changes and/or an immediate problem as soon as the data is read from the RFID tag 20 and also to receive more detailed feedback once the data has been analysed by the remote server. For example, the analysis of the remote server may suggest changes to driving style that would prolong the lifetime of the tyres.

Typically, the remote server is arranged to receive information relating to a plurality of vehicles (e.g. each vehicle in a fleet); a plurality of drivers (e.g. so that the performance of drivers can be compared); and/or a plurality of times (e.g. so that wear on the tyre can be tracked).

In order to enable vehicles and/or tyres to be identified, the computer device 30 may be arranged to query the user to input a vehicle identifier and/or a tyre identifier. Equally, the tread depth gauge may be arranged to determine an identifier relating to a vehicle and/or a tyre and to write this identifier to the RFID tag 20. In practice, the tread depth gauge may be used with tyres that comprise identifiers (e.g. tyre identifying RFID tags); these identifiers can be detected by a sensor in the tread depth gauge before the tread depths are measured. The identifiers can then be written to the RFID tag and thereafter read by the computer device.

Therefore, where the two measurements are taken as described with reference to FIG. 3a, the RFID tag may comprise four entries: 1. The tyre ID of the front-left tyre; 2. The front-left tyre tread depth; 3. The tyre ID of the rear-left tyre; 4. The rear-left tyre tread depth.

The computer device 30 may interpret the measurements based on the order of the measurements on the RFID tag 20 and/or based on the format of the measurements. For example, an identifier is likely to have a different format to a tread depth.

In some embodiments, the sensor and/or the transmitter of the tread depth sensor is arranged to write the measurements to the RFID tag 20 along with interpreting information, for example the sensor may write to the RFID tag the string: “front left tyre-2 mm”. This enables the computer device 30 to straightforwardly read and interpret the measurements written on the RFID tag.

Typically, the tread depth gauge is configurable, so that a user can define the format in which measurements are written to the RFID tag 20. This enables the tread depth gauge to be configured to work with a variety of computer devices and/or a variety of applications on the computer device 30.

In some embodiments, the tread depth gauge comprises a display (e.g. a liquid crystal display or an array of light emitting diodes) that indicates to the user measurements to be taken. These measurements may be determined based on a predetermined order; for example, a tread depth gauge may be preconfigured to require four measurements before each upload (one for each tyre) or to require three measurements before each upload (one for each tread on a tyre with three treads, or one from the outer, one from the centre and one from the inner tread). The display may comprise a light that indicates when a measurement has been taken or needs to be taken; for example a light may turn on once a measurement has been taken or turn from red to green. This enables a user to track their progress.

In some embodiments, the display on the tyre gauge is arranged to operate in dependence on the computer device. For example, the computer device may indicate to the tread depth gauge (e.g. via the RFID tag 20) measurements to be taken. The tread depth gauge may then provide this indication to the user via the display. For example, the tread depth gauge may comprise a display that shows a measurement to be taken to the user (e.g. the display may be a screen that shows “measure the front-left tyre next”).

The display may be arranged in one or more of the following ways:
To display a measurement to be taken and/or to enable the user to select a measurement to be taken. For example, the display may tell the user which tread depth to measure next and/or the display may allow the user to cycle through a list of tread depths to select the tread depth to measure next.
To display a value of a measurement (e.g. after the user has measured the tread depth, the display may show the measurement to the user).

Typically, the tread depth gauge is unaware of the meaning of a measurement that has been taken; the tread depth gauge typically records that a tread depth is a certain value, but is not aware of the tyre with which this tread depth is associated. In some embodiments, the tread depth gauge is arranged to receive an indication of the tyre associated with a measurement. This may be implemented via a user input on the tread depth gauge that enables the user to input a tyre to be associated with a previous or upcoming measurement. Equally, the tread depth gauge may be arranged to receive a tyre association via a component in a tyre; in particular, the tread depth gauge may be arranged to receive a tyre identifier via an RFID tag in a tyre. The display on the tread depth gauge may be arranged to operate in dependence on the indication of the tyre; for example, the display on the tread depth gauge may turn on a light associated with the indicated tyre.

In some embodiments, the tread depth gauge is arranged to store a template of measurements to be taken. For example, the tread depth gauge may store a first template for a motorbike, a second template for a car, and a third template for a bus, where each template requires different measurements to be taken. The user may then be able to select the template to use (and the display may indicate to the user the measurements that are required for this template). The computer device 30 may correspondingly be arranged to interpret the measurements on the RFID tag 20 based on a template. For example, the user may select a template on the computer device that enables the user to interpret the measurements.

In some embodiments, template information is written to the RFID tag 20 by the tread depth gauge, so that the computer device 30 can determine the template that has been used based on the template information and can then interpret the measurements on the RFID tag based on the determined template.

Similarly, the tread depth gauge may be arranged to store a user profile. Different users may have different preferences; for example, a first user may prefer to transmit each measurement to the computer device immediately following the taking of the measurement, whereas a second user may prefer to take all the measurements required for a vehicle before transmitting all of these measurements to the computer device in one go. The tread depth gauge may be arranged to store user profiles and/or preferences that relate to such preferences. These preferences may be downloaded to the gauge from the computer device (e.g. via the RFID tag 20, where the tread depth gauge may comprise a processer for reading information from the RFID tag).

It will be appreciated that aspects described with reference to the computer device 30 may also, or alternatively, be implemented on the tread depth gauge and vice versa. For example, a user may be able to identify a tyre with which to associate a measurement on the tread depth gauge, on the computer device, or on either of the tread depth gauge and the computer device.

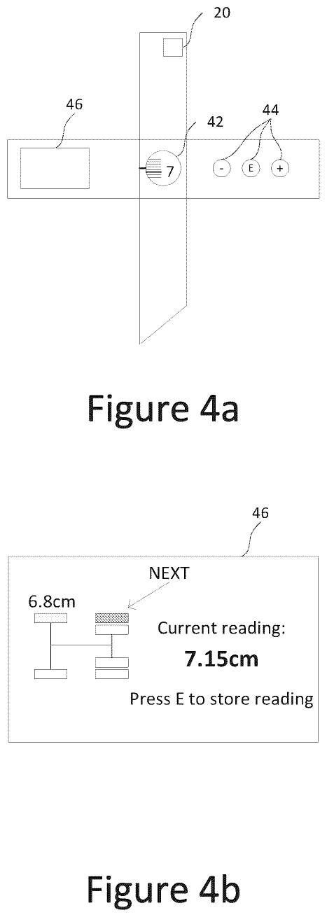

Referring to FIGS. 4a and 4b, there is described an embodiment of the tread depth gauge comprising a plurality of optional features. It will be appreciated that these features may be provided (or not be provided) in any combination.

This embodiment of the tread depth gauge comprises:
A manual sensor 42; this manual sensor lets a user read a tread depth even if the electronics of the tread depth gauge are not working (or if the user does not wish to use these electronics).
A user input 44; this user input enables a user to control the tread depth tyre gauge, for example to select a tyre to which a measurement applies.
A display 46. An exemplary embodiment of the display is shown in FIG. 4b. The display may, for example, show: a current measurement; previously taken measurements and the tyres with which these measurements are associated; and a tyre that will be associated with the next measurement. The user may be able to select this tyre for the next measurement using the user input, or using a touch sensitive display.

With the embodiment of the tread depth gauge that is shown, the two arms are arranged to interact to control aspects of the tread depth gage. For example, when the two arms are aligned the tread depth gauge may turn off. Similarly, when the two arms are moved away from alignment the tread depth gauge may turn on and/or perform a calibration process.

The measurements may be written to the RFID tag 20 in dependence on the user input 44 and/or the display 46. In particular, the user may be able to view measurements using the display in order to ensure that each measurement that has been taken is associated with the correct tyre. The user may then be able to write the measurements to the RFID tag using the user input. These measurements can be written to the RFID tag along with information that enables the computer device to determine the tyre associated with each measurement. Such an arrangement enables the user to discard a measurement if it was incorrectly obtained and ensures that unwanted information is not written to the RFID tag. So that measurements can be stored temporarily before being written to the RFID tag, the tread gauge may comprise memory, such as flash memory or RAM.

In some embodiments, the measurements are written to the RFID tag 20 as soon as they are taken. In such embodiments, the taking of a measurement may involve operation of a user input (e.g. so that the user can check the gauge is properly positioned using the manual sensor before the measurement is taken and written to the RFID tag.

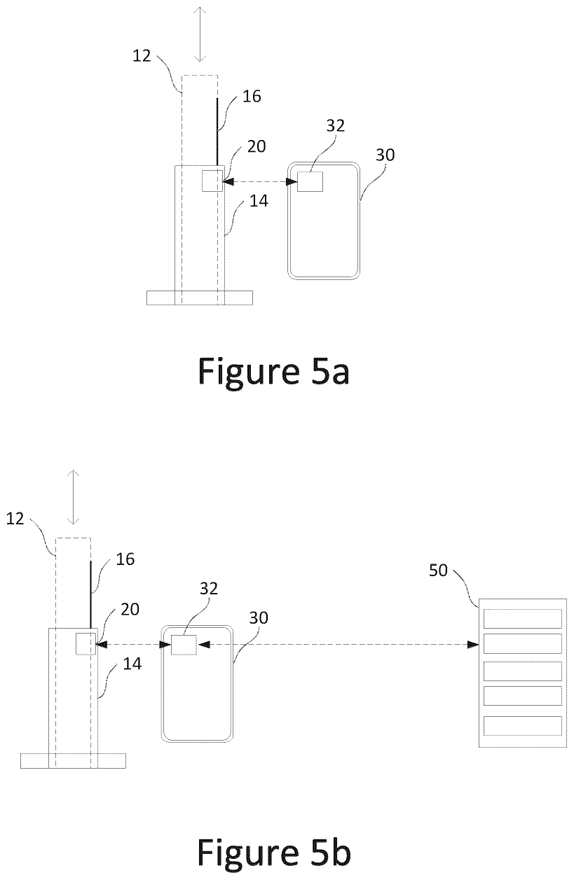

Referring to FIG. 5a, there is described a system comprising the tread depth gauge and the computer device 30. As shown, the computer device comprises a communication interface 32 that is arranged to interact with the RFID tag 20 of the tread depth gauge so as to read data from the RFID tag and/or to write data to the RFID tag. Typically, this communication interface is arranged to interact with the RFID tag via near-field communication (NFC) protocols.

The computer device 30 may be able to receive measurements from a plurality of tread depth gauges, so that measurements from various gauges can be evaluated together on the computer device. Typically, a remote server is used to evaluate measurements from various gauges and/or computer devices.

In this regard, referring to FIG. 5b there is described a system that further comprises a remote server 50 arranged to receive information from the computer device 30. This remote server may be used to receive measurements from a plurality of tread depth gauges/computer devices and/or to perform detailed analysis on measurements. The remote server may be arranged to receive measurements from the computer device via RFID; however, typically the remote server is arranged to receive the measurements via an area network (e.g. WiFi and/or ethernet) and/or via 2G, 3G, 4G, and/or 5G so that proximity is not required. Therefore, the computer device may comprise a communication interface arranged to receive/transmit via RFID and also arranged to receive/transmit information via an area network and/or 2G, 3G, 4G, and/or 5G.

The disclosed tread depth gauge is particularly useful for large vehicles, such as mining vehicles. With such vehicles, the computer device may be arranged to require a plurality of tread depth measurements (e.g. an outer tread depth, a middle tread depth, and an inner tread depth). Typically, the computer device 30 is arranged to receive a plurality of tread depths for each tyre, and to receive the tread depths for a first tyre before requesting the tread depths for a second tyre.

The tread depth gauge of the present disclosure may be used with any type of vehicle, where the computer device 30 is able to interpret the data on the RFID tag 20 based on a user input (e.g. to specify a type of vehicle and the meaning of each measurement on the RFID tag).

Indeed, while the detailed description has considered the use of a tread depth gauge, more generally it will be appreciated that the RFID tag may be used in combination with any sensor and/or measurement. The present disclosure is in particular applicable to vehicle sensors and/or tyre sensors, such as tread depth gauges, pressure gauges, temperature gauges etc. The present disclosure may also be used in a combined gauge, which may for example measure both pressure and tread depth. Similarly, the present disclosure may be used for any type of vehicle, e.g. cars, trucks, mining vehicles, aircraft, buses, etc. It will be appreciated that this gauge is also beneficial in other situations, in particular in situations where a gauge is used to obtain a plurality of readings and to upload these readings to a computer device.

### ALTERNATIVES AND MODIFICATIONS

It will be understood that the present invention has been described above purely by way of example, and modifications of detail can be made within the scope of the invention.

Reference numerals appearing in the claims are by way of illustration only and shall have no limiting effect on the scope of the claims.

1. A tyre gauge comprising:
an RFID device:
a sensor arranged to:
obtain a measurement from a tyre; and
write the measurement to the RFID device.

2. The tyre gauge of claim 1, further comprising a wire and/or a cable connecting the sensor to the RFID device such that the sensor is able to write the measurement to the RFID device.

3. The tyre gauge of claim 1, further comprising a transmitter arranged to emit an electromagnetic wave containing the measurement so as to write the measurement to the RFID device.

4. The tyre gauge of claim 1, wherein the tyre gauge is arranged to clear data on the RFID device and/or wherein the tyre gauge is arranged to clear data on the RFID device in dependence on a user input.

5. The tyre gauge of claim 1, wherein the sensor is arranged to:
write a plurality of measurements to the RFID device; and/or
append a measurement to data already on the RFID device; and/or
overwrite data on the RFID device.

6. The tyre gauge of claim 1, further comprising a power supply, wherein:
the power supply is arranged to provide power to one or more of: the RFID device, the sensor, and the means for writing; and/or
the power supply is arranged to receive power from a device reading data from the RFID device.

7. The tyre gauge of claim 1, further comprising one or more of:
a passive RFID device; and
an active RFID device.

8. (canceled)

9. The tyre gauge of claim 1, wherein the tyre gauge is arranged so that the measurement on the RFID device is cleared and/or overwritten upon the measurement being read by a separate computer device.

10. The tyre gauge of claim 1, wherein a mode of the RFID device is dependent on one or more of:
a time between successive measurements;
a user input; and
an input from a separate computer device.

11. The tyre gauge of claim 1, wherein:
in a first mode the transmitter is arranged to append the measurement to data already on the RFID device; and/or
in a second mode the transmitter is arranged to clear and/or overwrite data already on the RFID device.

12. (canceled)

13. The tyre gauge of claim 1, comprising a user input, wherein the RFID device is arranged to transmit the measurement to a separate computer device in dependence on an operation of the user input.

14. (canceled)

15. The tyre gauge of claim 13, wherein the user input is arranged to enable the user to select a tyre with which to associate a measurement.

16. The tyre gauge of claim 13, wherein:
the user input is arranged to enable the user to select a mode of operation and/or a template; and/or
the user input is arranged to enable the user to alter user preferences and/or to select a user profile.

17. The tyre gauge of claim 13, wherein:
the measurement is written to the RFID device in dependence on the user input; and/or
the measurement is written from a memory of the tyre gauge to the RFID device of the tyre gauge in dependence on the user input.

18. The tyre gauge of claim 2, wherein:
the tyre gauge is arranged to identify a tyre and/or vehicle associated with the measurement by reading an RFID chip associated with the tyre and/or vehicle; and/or
the transmitter is arranged to include in the electromagnetic wave an identifier of a tyre and/or vehicle associated with the measurement.

19. (canceled)

20. (canceled)

21. The tyre gauge of claim 1, being a tyre tread depth gauge.

22. A system comprising:
the tyre gauge of claim 1; and
a computer device arranged to read the measurement from the RFID device.

23. (canceled)

24. (canceled)

25. The system of claim 22, including a/the remote server, wherein the server is arranged to analyse a plurality of measurements, wherein the plurality of measurements are associated with one or more of:
a plurality of vehicles;
a plurality of times; and
a plurality of drivers.

26. (canceled)

27. The system of claim 22, comprising a plurality of tyre gauges, wherein the computer device and/or a/the remote server is arranged to receive measurements from each of the plurality of tyre gauges.

28. (canceled)

29. (canceled)

30. (canceled)

31. A method of obtaining a measurement relating to a tyre, the method comprising:
obtaining a measurement from the tyre using a sensor of a tyre gauge;
writing the measurement to an RFID device of the tyre gauge using a transmitter of the tyre gauge; and
reading the measurement from the RFID device using a separate computer device.

32. (canceled)

33. (canceled)

34. (canceled)
